(19) United States
(12) Patent Application Publication
(10) Pub. No.: US 2012/0273239 A1
(43) Pub. Date: Nov. 1, 2012

(54) FLAME TRAP CARTRIDGE, FLAME ARRESTOR, METHOD OF PREVENTING FLAME PROPAGATION INTO A FUEL TANK AND METHOD OF OPERATING AN AIRCRAFT

(76) Inventor: Susan BRENNAN, Poole (GB)

(21) Appl. No.: 13/454,151

(22) Filed: Apr. 24, 2012

(30) Foreign Application Priority Data
Apr. 28, 2011 (GB) 1107087.7

(51) Int. Cl. A62C 3/08; F23D 14/82

(52) U.S. Cl. 169/45; 220/88.2; 431/346

(57) ABSTRACT

The invention provides a flame trap cartridge 154 for use in a flame arrestor 50, the flame trap cartridge comprising a casing 160, and a foam component 170 having two opposite ends and at least one side edge, wherein the foam component is at least partially encased around at least one side edge by the casing. The invention also provides a flame arrestor, a method of preventing flame propagation into a fuel tanks and a method of operating an aircraft.

### BACKGROUND OF THE INVENTION

The present invention concerns flame trap cartridges. More particularly, this invention concerns flame trap cartridges for use in a flame arrestor or vent passage of an aircraft. The vent passage may be associated with a fuel tank of an aircraft. The fuel tank may be a main storage tank, an auxiliary tank, a surge tank or a vent tank. More particularly, the invention concerns flame trap cartridges comprising a casing.

Typical flame arrestors are located outboard in an aircraft wing, as shown in FIGS. 1 and 2. FIG. 1 shows a partial view of an aircraft 1 with a fuselage 10, port wing 11 and starboard wing 12. The fuselage 10 contains a fuselage fuel tank 20 in between the wings. The port wing 11 contains a port wing tank 21 and the starboard wing contains a starboard wing tank 22. At the outboard end of each wing is a surge tank. 23 designates the port surge tank and 24 designates the starboard wing surge tank.

The port wing tank 21 is provided with a port tank vent pipe 31 leading from the tank 21 to the port surge tank 23. The starboard wing tank 22 is provided with a starboard tank vent pipe 32 leading from the tank 22 to the starboard surge tank 24. The fuselage fuel tank 20 is provided with a fuselage fuel tank vent pipe 30 leading from the tank 20 to the port surge tank 23.

Each surge tank 23, 24 is provided with a surge tank vent pipe. 41 designates the port surge tank vent pipe and 42 designates the starboard surge tank vent pipe. Each surge tank vent pipe 41, 42 is provided with a flame arrestor (indicated in general as 50). 51 designates the port flame arrestor and 52 designates the starboard flame arrestor.

FIG. 2 shows an enlarged front sectional view of part of the wing box for the port wing 11, showing the flame trap arrestor 51. The wing 11 has a substantially vertical end rib 11a, an upper skin lib, a lower skin 11c and an end plate 11d. These 4 components define the surge tank 23 located at the end of the wing 11. The surge tank 23 may also have other ribs (not shown). FIG. 2 shows the port tank vent pipe 31 leading to the surge tank 23. (Equally, this could be the fuselage tank vent pipe 30 as this also leads to the port surge tank 23.) In the surge tank 23 is the port surge tank vent pipe 41. This pipe 41 has a bellmouth 41a at its upper, outboard end, a flattened (substantially horizontal) central portion 41b and a lower end 41c that exits to the atmosphere through the lower skin 11c of the wing 11. The flame arrestor 51 is located in the central portion 41b of the pipe 41.

FIG. 3 shows a schematic side view of the flame arrestor, shown generally as 50 (as the following description applies equally to the port flame arrestor 51 and starboard flame arrestor 52). The flame arrestor 50 comprises a cylindrical casing 53 with an outer diameter 53a and an inner diameter 53b (shown in FIG. 4).

A left hand end (as shown in FIG. 3) faces the bellmouth 41a/42a of the surge tank vent pipe 41/42. At this end, the casing 53 has an attachment point 53c for attaching a flame trap cartridge 54. The flame trap cartridge 54 (as shown in more detail in the end view of FIG. 4) is shown with a series of 9 concentric circles of sheet metal 56 with a series of 9 crimped/corrugated metal 55 in between the sheet metal 56. However, this is only a schematic view. In reality, the crimped/corrugated metal 55 and the sheet metal 56 are wrapped around themselves to form an interwoven spiral of the two different components 55, 56. Also, in reality, there is likely to be much more than 9 series of layers. For example, there could be approximately 30 series of layers. In other words, there could be approximately 30 layers of crimped/corrugated metal 55 interwoven with approximately 30 layers of sheet metal 56.

The metal for these components 55, 56 is usually stainless steel. The crimped/corrugated metal and the sheet metal 56 thus define a large number of longitudinal passages 57 through the flame trap cartridge 54. In the centre of the flame trap cartridge, there is a blocking member 58 filling the space inside the most central sheet metal circle to block the passage of fluid through that part of the flame trap cartridge 54. Thus, any fluid passing through the flame trap cartridge 54 must pass through one of the longitudinal passages 57.

A right hand end (as shown in FIG. 3) faces the atmosphere ext 41c/42c of the surge tank vent pipe 41/42. At this end, the casing 53 has an attachment point 53d for attaching ice protector stages 59. There are 3 ice protector stages, labelled from left to right 59a, 59b and 59c.

The flame trap cartridge 54 acts to prevent flame propagation into a fuel tank 20/21/22 by presenting the series of longitudinal passages 57 to a flame outside of the fuel tank. The longitudinal passages 57 are known to prevent flame propagation in a number of ways. Firstly, the stainless steel material 55, 56 absorbs heat from the flame front.

Secondly, the flame is accelerated by the reduction in area from the narrow passages 57. This causes the flame to exceed its combustion speed. A flame will only pass through the flame trap cartridge 54 when the Peclet number is high enough (higher than about 40 to 100). Therefore, the flame trap cartridge is designed to lower the Peclet number.

The Peclet number is defined as:

Pe_{L}=LV/α

where L=characteristic length (i.e. diameter of passages 57)

V=flame velocity, and

α=thermal diffusivity (for stainless steel, approximately 4.2×10⁻⁶ m²/s).

Hence, if the characteristic length (L) is low enough, the flame trap cartridge 54 will prevent flame propagation. In other words, if the diameter of the passages 57 is small enough, flame propagation is prevented. This is known as the “flame quenching diameter”.

The flame can be prevented from propagation for as long as the stainless steel 55, 56 is able to absorb a sufficient amount of heat from the flame. As soon as the stainless steel has heated up to a certain point, the local properties have changed such that the flame is no longer contained by the flame trap cartridge. This results in the flame reaching the other side of the flame arrestor. This is known as “flash back”.

Current flame arrestors 50 with existing flame trap cartridges 54 are capable of preventing flame propagation for approximately 5 minutes. However, it is clearly desirable from a safety point of view to increase this time. An aim of the invention is to increase this “resistance” time to greater than 5 minutes.

In addition, a disadvantage of current flame trap cartridges is that the required crimped metal causes a restriction in the vent passage of the aircraft. When refuel overflow of an aircraft occurs, excess fuel is allowed to spill from the fuel tanks through the vent pipes. Hence, the restrictions in the starboard and port surge tank vent pipes from the narrow passages can cause the pressure in the fuel tanks to rise to dangerously high levels. Therefore, a flame trap cartridge that imposes less of a restriction during refuel overflow is desired.

This desired feature is in direct contrast with the desired feature of increasing the resistance time for which flame propagation can be prevention. This is because, traditionally, flame trap cartridges are provided with narrower channels to increase this “resistance” time. However, making the channels narrower increases the restrictions in the vent passage and this can be dangerous in the event of refuel overflow.

In addition, new aircraft have different aerodynamic considerations and often have thinner wings (i.e. less height between the upper and lower wing skins) and therefore less space available in the wings for the surge tank vent pipes. Furthermore, the vent pipes must often be a non-uniform, curved/bent shape to avoid stringers, ribs etc. in the wing. Hence, a flame trap cartridge or flame arrestor that is able to fit in a more confined space, and/or an irregular space is desired.

The present invention seeks to mitigate the above-mentioned problems. Alternatively or additionally, the present invention seeks to provide an improved flame trap cartridge or flame arrestor.

### SUMMARY OF THE INVENTION

The present invention provides, according to a first aspect, a flame trap cartridge for use in a flame arrestor or vent passage, the flame trap cartridge comprising a casing, and a foam component having two opposite ends and at least one side edge, wherein the foam component is at least partially encased around at least one side edge by the casing.

Providing a foam component provides a series of channels in a similar way to the prior art flame trap cartridges made of crimped stainless steel. However, the foam component is able to be cut, machined, or otherwise made, into a wide variety of different shapes and sizes and so can be located in, or in a portion of, a vent passage or flame arrestor that is not of a uniform shape. In addition, the foam component provides a series of non-uniform channels that force a flame to change direction as it attempts to pass through. It is believed that such a feature enhances the flame resistance properties of the foam, compared to having linear channels. Hence, the resistance time of the foam is increased, in comparison to prior art crimped metal flame trap cartridges. This can be done without substantially narrowing the channels (or pores/cells) in the flame trap cartridge and so without substantially adversely affecting the passage of fuel though the vent passage during refuel overflow.

A foam component can be defined as a component made of foam material, such that the component has cells and cell ligaments. The cells and cell ligaments define passages or channels to provide paths through the foam component. The foam component may comprise metal (for example, titanium) foam, ceramic foam, polymer foam or carbon foam, for example. The foam component does not have to be substantially compressible.

Preferably, the foam component provides a tortuous path between the two opposite ends for fluid to pass through.

Preferably, the foam component provides a path between the two opposite ends for fluid to pass through, wherein the path comprises a series of passageways extending in a variety of directions.

Preferably, the foam component comprises a foam with a regular pattern of cells and cell ligaments.

Preferably, the foam component comprises a foam with a regular pattern of truncated octahedron cells and cell ligaments. A truncated octahedron consists of 6 square faces on 8 hexagonal faces. Such a structure is known as a Kelvin structure.

Preferably, the foam component comprises a reticulated foam material. A reticulated foam material typically is a very porous, low density solid foam. In other words, they are “net-like” with typically very few complete cell “bubbles” present.

Preferably, the foam component comprises a skeletal foam structure. For example, the foam component may be substantially incompressible. A skeletal foam typically has a very low density (about 10%) and a very high void volume (about 90%). These characteristics mean that for a similar size of crimped stainless steel prior art flame trap cartridge, the flame trap cartridge according to an embodiment of the present invention can be much lighter and provide less of a restriction during refuel overflow.

Preferably, the foam component comprises a substantially rigid foam structure. In other words, the foam is substantially incompressible.

Preferably, both opposite ends of the foam component are at least partially exposed from the casing to provide a fluid path between opposite ends of the flame trap cartridge through the foam component. Of course, one or both ends could be completely exposed.

Preferably, both opposite ends of the foam component are substantially fully exposed from the casing. If both ends are fully exposed, the casing is only present on the side edges of the foam component.

Preferably, the foam component is encased around each of its side edges by the casing. In other words, casing is present around the whole of the circumference of the foam component. The side edges may be fully or partially covered by the casing.

Preferably, the outside of the casing is provided with an attachment mechanism for attaching the flame trap cartridge inside a pipe. This allows the flame trap cartridge to be attached inside a vent passage or inside a flame arrestor.

Preferably, the foam component is a non-uniform shape. This allows the flame trap cartridge to be used in a vent passage and/or flame arrestor with a non-uniform shape. For example, a flame trap cartridge according to an embodiment of the present invention could be used in a curved portion of a vent passage. This allows the flame trap cartridge to be used in aircraft wings, for example, where space is limited. Preferably, the foam component is provided with at least one curved portion along the axis between the two opposite ends. This allows the foam component to fit in a curved portion of a vent passage. Preferably, the foam component has a varied diameter between the two opposite ends. This allows the foam component to fit in a portion of a vent passage with a varied diameter, for example, a converging or diverging vent passage.

Alternately, the foam component is in the shape of a disc, such that the opposite ends of the foam component are the planar surfaces of the disc, and side edge of the foam component extends around the circumference of the disc.

Preferably, a flame arrestor is provided comprising a flame trap cartridge as described above.

According to a second aspect of the invention there is also provided a flame arrestor comprising a foam component having two opposite ends and at least one side edge, wherein the foam component is at least partially encased around at least one side edge by the flame arrestor.

Providing a foam component provides a series of channels in a similar way to the prior art flame arrestors. However, the foam component is able to be cut, machined, or otherwise made, into a wide variety of different shapes and sizes and so can be located in, or in a portion of, a vent passage that is not of a uniform shape. In addition, the foam component provides a series of non-uniform channels that force a flame to change direction as it attempts to pass through. It is believed that such a feature enhances the flame resistance properties of the foam, compared to having linear channels. Hence, the resistance time of the foam is increased, in comparison to prior art flame arrestors containing crimped metal flame trap cartridges. This can be done without substantially narrowing the channels (or pores/cells) in the flame arrestor and so without substantially adversely affecting the passage of fuel though the vent passage during refuel overflow.

Preferably, the flame arrestor includes any of the further features as described above.

Preferably, an aircraft or part of an aircraft, such as an aircraft wing, is provided comprising a flame trap cartridge or flame arrestor as described above.

According to a third aspect of the invention there is also provided a method of preventing flame propagation into a fuel tank, the method comprising the steps of providing a fuel tank, providing a vent passage for fuel or fuel vapour from the fuel tank, providing the vent passage with foam material.

Preferably, the foam material is provided so as to provide a tortuous path through the vent passage for fluid to pass through.

Preferably, the foam material is provided so as to provide a path through the vent passage for fluid to pass through, wherein the path comprises a series of passageways extending in a variety of directions.

Preferably, the method comprises the step of manufacturing the foam material using Rapid Prototyping. For example, the foam material could be manufactured using Additive Layer Manufacture (ALM), 3D printing, laser sintering (including direct metal laser sintering) or stereolithography.

According to a fourth aspect of the invention there is also provided a method of operating an aircraft, the method comprising the step of venting a fuel tank of an aircraft through a vent passage, wherein the vent passage is provided with foam material.

Preferably, the vented fluid is vented through a tortuous path through the foam material.

Preferably, the vented fluid is vented through a series of passageways in the foam material, the passageways extending in a variety of directions.

It will of course be appreciated that features described in relation to one aspect of the present invention may be incorporated into other aspects of the present invention. For example, the methods of the invention may incorporate any of the features described with reference to the apparatus of the invention and vice versa. For example, features of the foam component of the flame trap cartridge or flame arrestor can equally apply to the foam material provided in the methods of preventing flame propagation into a fuel tank and operating an aircraft.

### DESCRIPTION OF THE DRAWINGS

Embodiments of the present invention will now be described by way of example only with reference to the accompanying schematic drawings of which:

FIG. 1 shows a plan sectional view of the wings of an aircraft, showing a flame arrestor in place;

FIG. 2 shows an enlarged front sectional view of part of one of the wings, showing the flame trap arrestor;

FIG. 3 shows a side view of a prior art flame arrestor including a prior art flame trap cartridge;

FIG. 4 shows an end view of a prior art flame trap cartridge;

FIG. 5 shows a perspective view of a flame trap cartridge according to a first embodiment of the invention;

FIG. 6 shows an enlarged view of the reticulated foam material used in the flame trap cartridge of FIG. 5;

FIG. 7 is a schematic drawing of a reticulated foam cell structure;

FIG. 8 shows a schematic drawing of a truncated octahedron reticulated foam cell structure; and

FIG. 9 shows a schematic drawing of a truncated octahedron cell packing arrangement.

### DETAILED DESCRIPTION

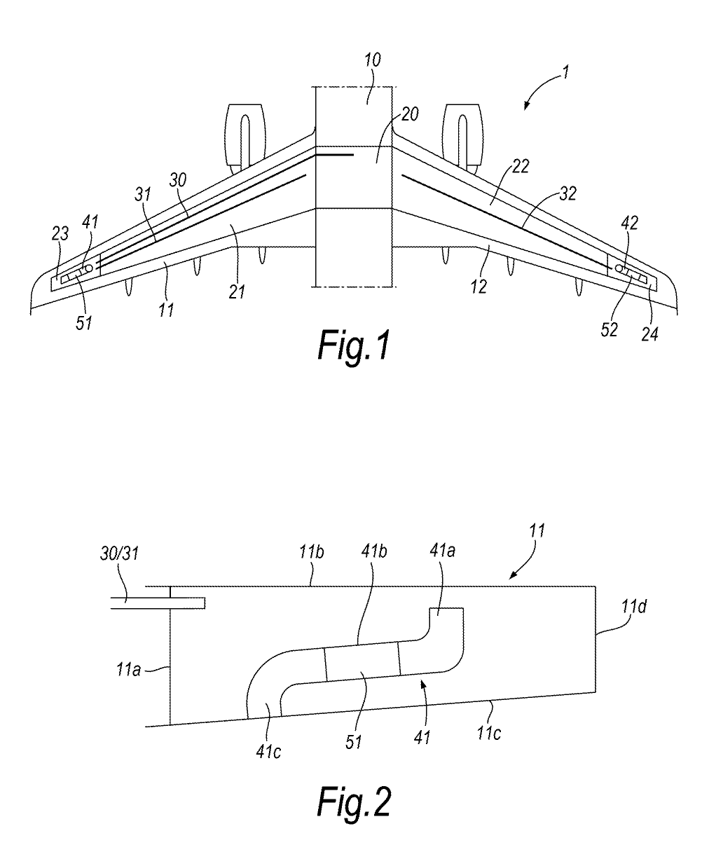

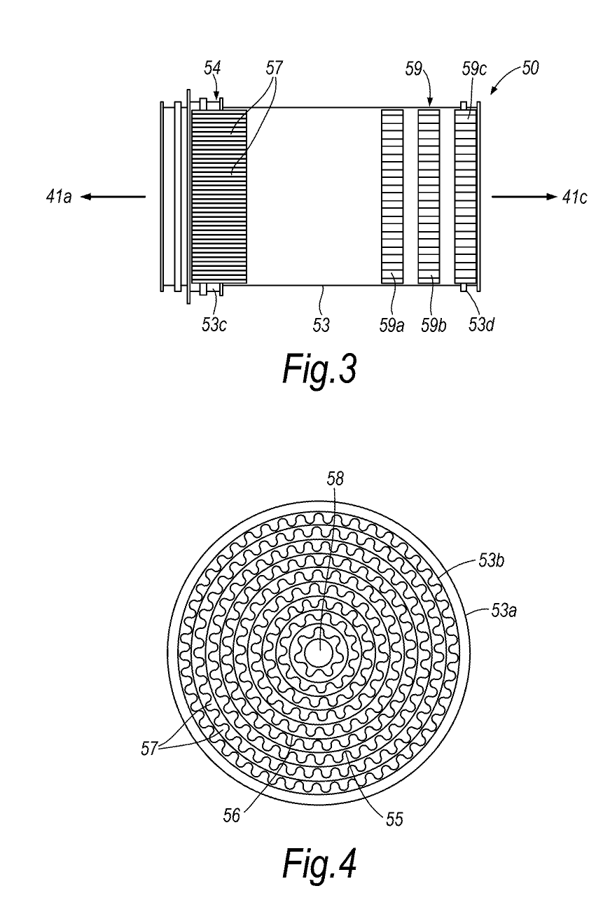

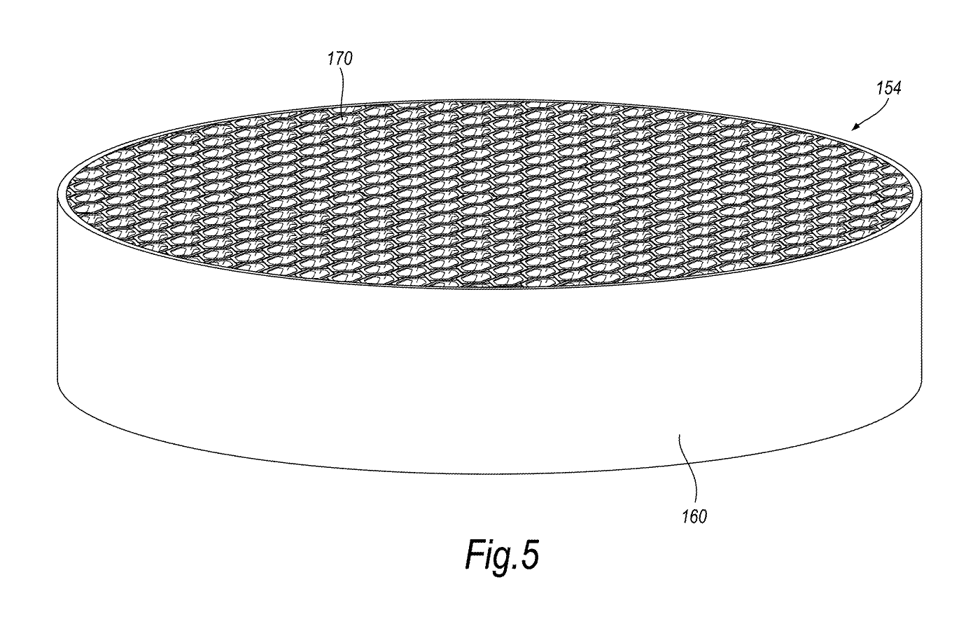

FIG. 5 shows a perspective view of a flame trap cartridge 154 according to a first embodiment of the invention. The flame trap cartridge 154 is for use in a flame arrestor, such as that described in relation to FIGS. 1 to 4, instead of prior art flame trap cartridge 54.

The flame trap cartridge 154 is a cylindrical disc with a circular casing 160 around its side edge circumference. Inside the casing 160 is a foam component 170 comprising reticulated foam material.

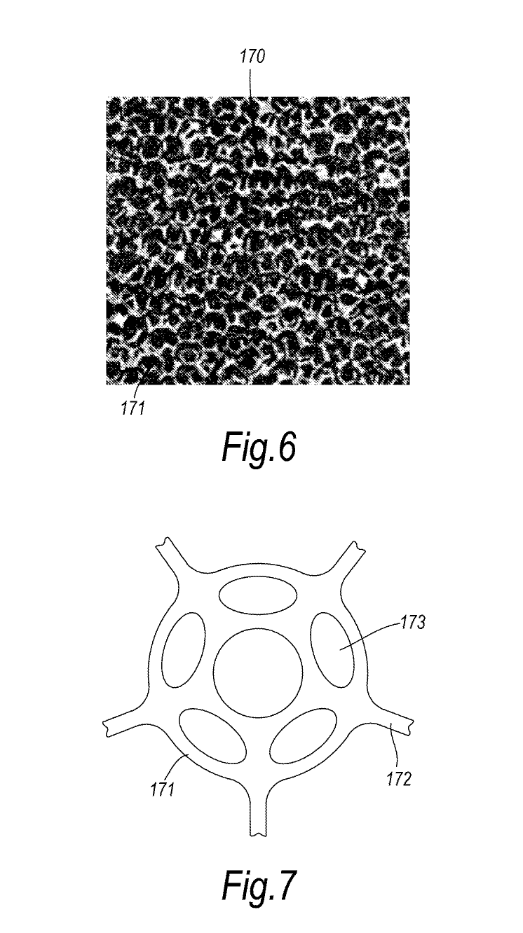

An enlarged view of the reticulated foam material 170 is shown in FIG. 6. FIG. 7 is a schematic drawing of a reticulated foam cell structure. Here, it can be seen that the cell structure comprises cells 171 formed where ligaments 172 join. Each cell 171 comprises a number of pores 173 in the cell. The pores 173 have a diameter of approximately 1.8 mm.

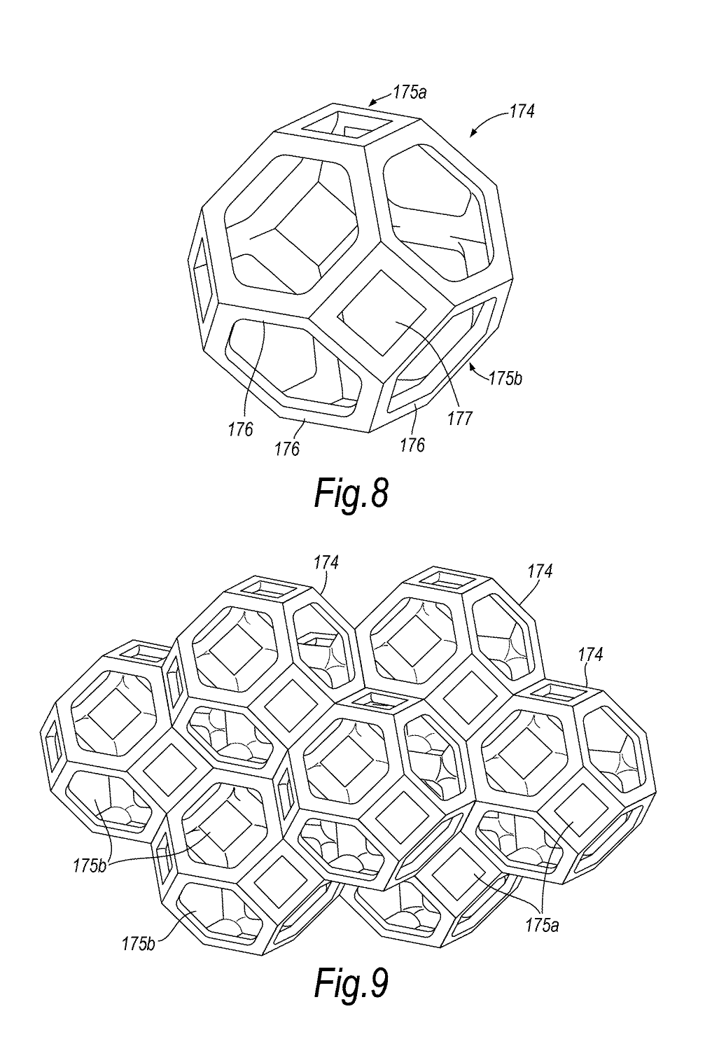

FIG. 8 shows a schematic drawing of a truncated octahedron reticulated cell 174. Here, the cell 174 is a truncated octahedron shape with 14 faces 175. There are 6 faces that are square-shaped faces 175a and 8 faces that are hexagonal-shaped faces 175b. Each face 175 of the cell consists of edge ligaments 176 in the shape of the face and a pore 177 inside the edge ligaments 176. The pores 177 have a diameter of approximately 1.8 mm.

FIG. 9 shows a schematic drawing of a truncated octahedron cell packing arrangement. Here it can be seen that the various truncated octahedron reticulated cells 174 are connected such that each square face 175a of one cell 174 connects to another square face 175a of other cells 174. Similarly, each hexagonal-shaped face 175b of one cell 174 connects to another hexagonal-shaped face 175b of other cells 174.

The foam material 170 is manufactured by a process called Additive Layer Manufacture (ALM). This process uses powdered titanium on a horizontal surface. The titanium is melted in a specified pattern to form a solid structure. Then another layer of titanium powder is melted on the top of the previously melted layer. In this way the cell ligaments 176 are built up in a specified pattern to form the truncated octahedron cell packing arrangement shown in FIG. 9. The process has a high degree of accuracy to the order of approximately 0.6 mm.

The foam material 170 can then be cut, machined, or otherwise made, into a wide variety of different shapes and sizes. It is then assembled into a casing 160 to form a flame trap cartridge 154. The flame trap cartridge 154 is later assembled into a flame arrestor 50 by attaching it to attachment point 53c. The flame arrestor 50 can then be assembled in a surge tank vent pipe 41/42 of an aircraft 1.

During refuel of the aircraft 1, fuel is pumped into the fuselage tank 20, port wing tank 21 and the starboard wing tank 22. During refuel, fuel vapour from these tanks flows through the fuselage tank vent pipe 30, port vent pipe 31 and the starboard tank vent pipe 32 respectively, into the port surge tank 23 and starboard surge tank 24. From here, the fuel vapour in the port surge tank 23 vents out to the atmosphere through the port surge tank vent pipe 41 and port flame arrestor 51 and the fuel vapour in the starboard surge tank 24 vents out to the atmosphere through the starboard surge tank vent pipe 42 and starboard flame arrestor 52.

When the fuel vapour is vented through the flame arrestors 51, 52, the vapour passes through the pores 177 of the cells 174 of the foam material 170 in the flame trap cartridge 154 and then through the ice protector stages 59a, 59b and 59c.

When refuel overflow occurs, excess fuel can be ejected from the tanks of the aircraft 1 by following the same path as described above;
i) from the fuselage tank 20, port wing tank 21 and the starboard wing tank 22,
ii) through the fuselage tank vent pipe 30, port vent pipe 31 and the starboard tank vent pipe 32,
iii) into the port surge tank 23 and starboard surge tank 24,
iv) venting through the port surge tank vent pipe 41 (including the port flame arrestor 51) and the starboard surge tank vent pipe 42 (including the starboard flame arrestor 52)
v) to the atmosphere.

In stage iv), the excess fuel is able to flow through the pores 177 of the cells 174 of the foam material 170 in the flame trap cartridge 154 and then through the ice protector stages 59a, 59b and 59c.

If there is a fire, flames are prevented from reaching the tanks of the aircraft 1 due to the flame arrestors 51, 52 and the foam material 170 contained in the flame arrestors 51, 52. The foam material 170 provides a series of channels in a similar way to the prior art flame trap cartridges made of crimped stainless steel. In addition, the foam material 170 provides a series of non-uniform channels that force a flame to change direction as it attempts to pass through. It is believed that such a feature enhances the flame resistance properties of the foam material 170, compared to the linear passages 57 of the prior art flame trap cartridge 54.

Hence, the resistance time of the foam is increased, in comparison to the prior art crimped metal flame trap cartridges 54. This can be done without substantially narrowing the channels in the flame trap cartridge and so without substantially adversely affecting the passage of fuel though the vent passage during refuel overflow.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

A variety of different foam materials could be used for the foam material 170. For example, strength is not a primary requirement. Much more important are the flame properties of the material used. However, the chosen material must not be too brittle as otherwise is could be easily broken or damaged during manufacture, assembly or use.

As another alternative, the foam material 170 does not have to be manufactured using the ALM process. It could be made by any other suitable process. For example, it could be made by another Rapid Prototyping method, such as 3D printing, laser sintering (including direct metal laser sintering) or stereolithography.

The foam material 170 and resulting flame trap cartridge 154 may be any shape, instead of a simple cylindrical disc shape. For example, the foam material 170/flame trap cartridge 154 may be curved, twisted or any other conventional or unconventional shape. The shape could be designed to fit into an irregularly shaped vent pipe. The desired shape of the foam could be achieved by being cut, machined, or otherwise made.

Alternatively, the foam material 170 is attached directly into a flame arrestor 50, without the need for a separate casing 160 around the foam material 170. The flame arrestor 50 can then be assembled in a surge tank vent pipe 41/42 of an aircraft 1.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A flame trap cartridge for use in a flame arrestor or vent passage, the flame trap cartridge comprising:
a casing, and
a foam component having two opposite ends and at least one side edge, wherein the foam component is at least partially encased around at least one side edge by the casing.

2. A flame trap cartridge according to claim 1, wherein the foam component provides a tortuous path between the two opposite ends for fluid to pass through.

3. A flame trap cartridge as claimed in claim 1, wherein the foam component provides a path between the two opposite ends for fluid to pass through, wherein the path comprises a series of passageways extending in a variety of directions.

4. A flame trap cartridge as claimed in claim 1, wherein the foam component comprises a foam with a regular pattern of cells and cell ligaments.

5. A flame trap cartridge as claimed in any claim 4, wherein the foam component comprises a foam with a regular pattern of truncated octahedron cells and cell ligaments.

6. A flame trap cartridge as claimed in claim 1, wherein the foam component comprises a reticulated foam material.

7. A flame trap cartridge as claimed in claim 1, wherein the foam component comprises a skeletal foam structure.

8. A flame trap cartridge as claimed in claim 1, wherein the foam component comprises a substantially rigid foam structure.

9. A flame trap cartridge as claimed in claim 1, wherein both opposite ends of the foam component are at least partially exposed from the casing to provide a fluid path between opposite ends of the flame trap cartridge through the foam component.

10. A flame trap cartridge as claimed in claim 9, wherein both opposite ends of the foam component are substantially fully exposed from the casing.

11. A flame trap cartridge as claimed in claim 1, wherein the foam component is encased around each of its side edges by the casing.

12. A flame trap cartridge as claimed in claim 1, wherein the outside of the casing is provided with an attachment mechanism for attaching the flame trap cartridge inside a pipe.

13. A flame trap cartridge as claimed in claim 1, wherein the foam component is a non-uniform shape.

14. A flame trap cartridge as claimed in claim 1 wherein the foam component is in the shape of a disc, such that the opposite ends of the foam component are the planar surfaces of the disc, and side edge of the foam component extends around the circumference of the disc.

15. A flame arrestor comprising a flame trap cartridge according to claim 1.

16. A flame arrestor comprising a foam component having two opposite ends and at least one side edge, wherein the foam component is at least partially encased around at least one side edge by the flame arrestor.

17. A flame arrestor according to claim 16.

18. An aircraft or part of an aircraft, such as an aircraft wing, including a flame trap cartridge according to claim 1.

19. A method of preventing flame propagation into a fuel tank, the method comprising the steps of:
providing a fuel tank,
providing a vent passage for fuel or fuel vapour from the fuel tank,
providing the vent passage with foam material.

20. A method of preventing flame propagation into a fuel tank according to claim 19, wherein the foam material is provided so as to provide a tortuous path through the vent passage for fluid to pass through.

21. A method of preventing flame propagation into a fuel tank according to claim 19, wherein the foam material is provided so as to provide a path through the vent passage for fluid to pass through, wherein the path comprises a series of passageways extending in a variety of directions.

22. A method of preventing flame propagation into a fuel tank according to claim 19 wherein the method comprises the step of manufacturing the foam material using Rapid Prototyping.

23. A method of operating an aircraft, the method comprising the step of:
venting a fuel tank of an aircraft through a vent passage, wherein the vent passage is provided with foam material.

24. A method of operating an aircraft according to claim 23, wherein the vented fluid is vented through a tortuous path through the foam material.

25. A method of operating an aircraft according to claim 23, wherein the vented fluid is vented through a series of passageways in the foam material, the passageways extending in a variety of directions.
